(19) United States
(12) Patent Application Publication
(10) Pub. No.: US 2025/0159650 A1
(43) Pub. Date: May 15, 2025

(54) Determining a Location of a Device Based on a Polygon Defined by Locations of Nearby Devices

(71) Applicant: Arista Networks, Inc., Santa Clara, CA (US)

(72) Inventors: Parag Mittal, Pune (IN); Rachit Srivastava, Pune (IN)

(73) Assignee: Arista Networks, Inc., Santa Clara, CA (US)

(21) Appl. No.: 18/507,942

(22) Filed: Nov. 13, 2023

(51) Int. Cl. H04W 64/00; G01S 19/39; H04W 24/02; H04W 52/28; H04W 84/12

(52) U.S. Cl. CPC H04W 64/003; G01S 19/396; H04W 24/02; H04W 52/283; H04W 84/12

(57) ABSTRACT

Techniques for enabling a communication device to determine a geographic location, corresponding to its own geographic location, by computing a polygon-shaped geographical region that surrounds the geographic location of the communication device are disclosed. To compute the polygon-shaped geographical region, a processor at the communication device selects a set of location information corresponding to received geographical coordinates of multiple location-enabled devices. The polygon-shaped geographical region is determined such that each of the plurality of location-enabled devices is located along a perimeter of the polygon-shaped geographical region and such that the communication device is located within the polygon-shaped geographical region.

### TECHNICAL FIELD

The present disclosure relates to a computer-implemented technique for defining a device location based on geographic locations of other devices. In particular, the present disclosure relates to determining, and reporting to a server, a target device's geographic location relative to geographic locations of multiple location-enabled devices.

### BACKGROUND

In wireless networking, an IEEE 802.11 device is configured to operate in accordance with permissions granted to the device. The permissions typically relate to temporal, spatial, and operational criteria to be followed by the device. For a given wireless device, the criteria may specify a permitted time, permitted place, and permitted operation metrics for the permitted time and place. For instance, a fixed access point device or a fixed client device may obtain authorization from a cloud Automated Frequency Coordination (AFC) system to operate via Wi-Fi 6 for a particular use case.

The use-case authorization may correspond to a specified time interval, a specified geographic location, a specified frequency such as 6 GHZ, and a specified transmit power. Each use-case authorization from the AFC system will typically correspond to a request, submitted for the device to the AFC system, for permission to operate the device in a fashion corresponding to the particular use case.

A request to the AFC system may include a geographic location of the device to be configured. The geographic location of the device may be determined based on positioning signals the device receives, for example, from a global positioning system (GPS) or cellular base station. In a sheltered or indoor environment, the device may be unable to acquire positioning signals sufficient to determine the geographic-location for reporting to the AFC system. For instance, GPS or cellular base station positioning signals that are insufficient, weak, or fragmentary may commensurately deter position determinations sought to be performed at the device.

The approaches described in this section are approaches that could be pursued, but not necessarily approaches that have been previously conceived or pursued. Therefore, unless otherwise indicated, it should not be assumed that any of the content or approaches described in this section qualify as prior art merely by virtue of their inclusion in this section.

### BRIEF DESCRIPTION OF THE DRAWINGS

The embodiments of this disclosure are illustrated by way of example and not by way of limitation in the figures of the accompanying drawings. It should be noted that references to “an” or “one” embodiment of the disclosure in this disclosure are not necessarily to the same embodiment of the disclosure, and they mean at least one. In the drawings:

FIG. 1 illustrates an example system including a target device and a configuration server in accordance with one or more embodiments of the disclosure;

FIGS. 2A and 2B show an example set of operations for configuring the target device based on data from the configuration server in accordance with one or more embodiments of the disclosure;

FIG. 3 depicts an example operating environment including the target device and including multiple location-enabled devices in accordance with one or more embodiments of the disclosure; and

FIG. 4 illustrates a block diagram that includes a computer system in accordance with one or more embodiments of the disclosure.

### DETAILED DESCRIPTION

In the following description, for the purposes of explanation, numerous specific details are set forth in order to provide a thorough understanding of the disclosure. One or more embodiments of the disclosure may be practiced without these specific details. Features described in one embodiment of the disclosure may be combined with features described in a different embodiment of the disclosure. In some examples, well-known structures and devices are described with reference to a block diagram form in order to avoid unnecessarily obscuring the present invention.
1. GENERAL OVERVIEW
2. DEVICE CONFIGURATION SYSTEM
3. DETERMINING A LOCATION OF A DEVICE FOR CONFIGURING THE DEVICE
4. EXAMPLE EMBODIMENT
5. HARDWARE OVERVIEW
6. MISCELLANEOUS; EXTENSIONS

### 1. General Overview

One or more embodiments define a location of a target device based on the location information of a set of GPS-enabled devices. In an example, the target device may be located within a building and the set of GPS-enabled devices may be disposed along a perimeter of the building. Initially, the GPS-enabled devices determine their own locations based on received GPS signals. The GPS-enabled devices then broadcast their respective locations, or otherwise transmit their respective locations using a mechanism that results in the target device receiving the respective locations of the GPS-enabled devices. The target device then uses the locations of the GPS-enabled devices to compute a polygon-shaped geographical region. The polygon-shaped geographical region is computed such that the locations of the GPS-enabled devices are located approximately along the perimeter of the polygon-shaped geographical region. In the above described example, where the set of GPS-enabled devices are disposed along the perimeter of the building, the polygon-shaped geographical region may correspond approximately to the perimeter of the building.

The target device (or another system) determines the location of the target device as a function of the polygon-shaped geographical region. The target device may be configured to compute a location of the target device as a function of the polygon-shaped geographical region based, in part, on knowledge that the target device is positioned within a geographical space and that the GPS-enabled devices are positioned along a perimeter of the geographical space. In an example, the target device is an access point that is known to be installed within a building and the GPS-enabled devices are access points known to be installed along the perimeter of the building.

The location of the target device may be defined as the polygon-shaped geographical region itself. Alternatively, or additionally, the target device may select a specific location within the polygon-shaped geographical region as the location of the target device. For example, an approximate center of the polygon-shaped geographical location may be computed and selected as the location of the target device. Furthermore, techniques such as triangulation may be used to select a location within the polygon-shaped geographical region for the target device that has been determined in accordance with one or more embodiments.

The location of the target device may be transmitted to a server with a request for location-based configuration data. The server may identify the location-based configuration data corresponding to configurations for devices within the polygon-shaped geographical region. The server may then transmit the location-based configuration data to the target device. The target device configures itself based on the location-based configuration data.

One or more embodiments of the disclosure described in this Specification and/or recited in the claims may not be included in this General Overview section.

### 2. Device Configuration System

A wireless communication device, such as an access point (AP), determines a polygon-shaped geographical region that describes a geographic location of the wireless communication device. In order to determine the polygon-shaped geographical region, the communication device is configured to receive location information corresponding to a geographic location of each of a plurality of location-enabled devices. At least a subset of the location-enabled devices may be configured to function in a wireless network as GPS-enabled access points. One or more processors at the communication device may perform computations using at least a selected subset of the location information to determine the polygon-shaped geographical region. The polygon-shaped geographical region is determined by the one or more processors such that each of the plurality of location-enabled devices is located approximately along a perimeter of the polygon-shaped geographical region and such that the communication device is located within the polygon-shaped geographical region.

In one or more embodiments, the communication device reports its current geographic location to a configuration server by identifying, to the configuration server, the polygon-shaped geographical region. The communication device may identify the polygon-shaped geographical region to the configuration server by transmitting coordinates corresponding to at least a selected subset of the geographic locations of the plurality of location-enabled devices. After identifying the polygon-shaped geographical region to the configuration server as the current geographic location, the communication device receives from the configuration server configuration data based on the reported current geographic location, and is configured based on the configuration data.

One or more embodiments define a geographic location of a wireless communication device based on location information associated with a set of GPS-enabled devices. The communication device may, for example, be located within a structure and the set of GPS-enabled devices may be disposed along a perimeter of the structure. Initially, the GPS-enabled devices determine their own geographic locations based on received GPS signals. The geographic locations of the GPS-enabled devices may correspond to points along the perimeter of the structure by virtue of the GPS-enabled devices being positioned along the perimeter of the e 5 structure. The GPS-enabled devices then broadcast their respective geographic locations, e.g., interiorly within the structure, for receipt by the communication device.

The communication device receives the broadcasts with the respective geographic locations. The communication device then selects and uses at least a subset of the geographic locations of the GPS-enabled devices to create a polygon-shaped geographical region. The polygon-shaped geographical region is computed by the communication device such that the geographic locations of the GPS-enabled devices are located approximately along the perimeter of the polygon-shaped geographical region. The geographic location of the communication device is defined, e.g., to one or more other devices, as a function of the polygon-shaped geographical region.

The geographic location of the communication device (i.e., the polygon-shaped geographical region determined to include the communication device) may be reported, e.g., transmitted, to a configuration server with a request for location-based configuration data. The configuration server may identify particular configuration data, corresponding to the polygon-shaped geographical region, for use by the communication device. The configuration server may then transmit the configuration data to the communication device. Subsequently, the communication device may configures itself based on the configuration data from the configuration server.

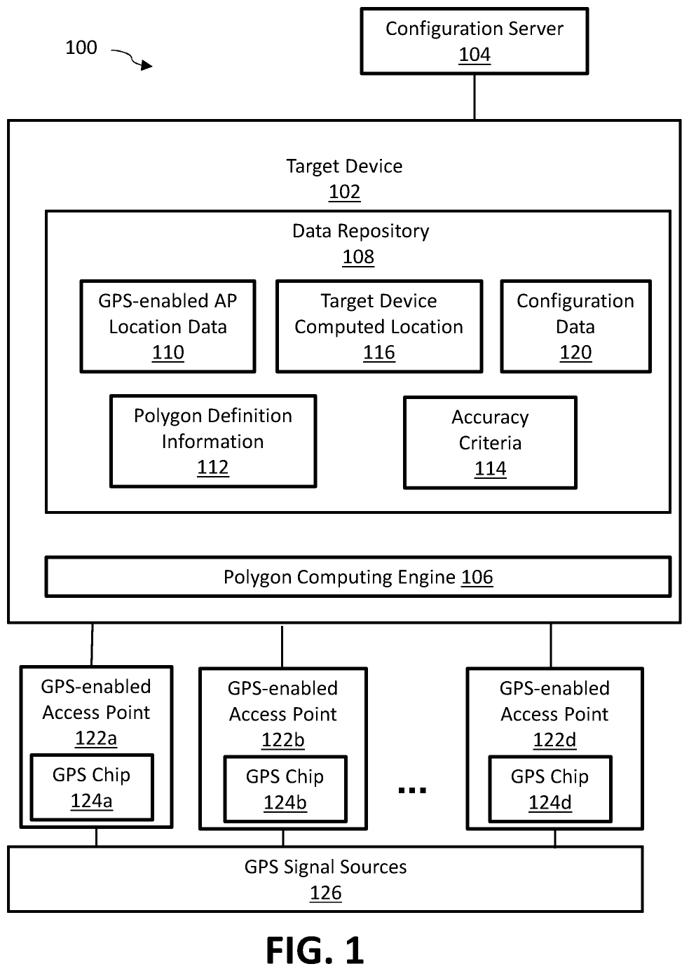

FIG. 1 illustrates a system 100 for configuring a wireless communication device to function within pre-set operating parameters in accordance with one or more embodiments. As shown in FIG. 1, the system 100 includes a target device 102, a configuration server 104, three or more GPS-enabled access points 122a-122n, and GPS signal sources 126. In one or more embodiments, the system 100 may include more or fewer components than the components illustrated in FIG. 1. The components illustrated in FIG. 1 may be local to or remote from each other. Various components illustrated in FIG. 1 may be implemented in software and/or hardware. Each component may be distributed over multiple applications and/or machines. Multiple components may be combined into one application and/or machine. Operations described with respect to one component may instead be performed by another component.

In accordance with one or more embodiments, the operating/functioning parameters are authorized for abidance by the target device 102 only during a pre-approved interval of time and only at or within a pre-authorized geographic location. In various embodiments including the illustrated example, the target device 102 comprises one or more hardware components and is communicatively coupled, directly or indirectly, directly or indirectly, e.g., via a wired and/or wireless communication link and/or network(s), to a configuration server 104.

In accordance with one or more embodiments, the target device 102 may comprise an access point configured to reports its geographic location to the configuration server 104 in order to receive authorization from the configuration server 104 for operation of the target device 102 within a set of preauthorized operating/functioning parameters during a pre-authorized interval of time and at a pre-authorized geographic location. For example, the target device 102 may be configured to report its geographic location, in the form of particular GPS coordinates or in the form of a polygon-shaped geographical region having a perimeter that encompasses the geographic location of the target device 102.

Points along the perimeter of the polygon-shaped geographical region may be used to describe a shape and geographic location of the polygon-shaped geographical region to the configuration server 104. For instance, the polygon-shaped geographical region may be a polygon, e.g., linear polygon, having three or more vertices corresponding to three or more sets of GPS coordinates. The target device may report its geographic location to the configuration server 104 using three or more sets of the GPS coordinates to define vertices of the polygon-shaped geographical region in which the target device is located.

In accordance with one or more embodiments, the target device 102 is an access point capable of operating in a 6 GHz frequency range and the configuration server 104 is an Automated Frequency Coordination (AFC) server. One of skill in the art will appreciate that the target device 102 and the configuration server 104 may take a variety of forms, be represented as multiple components, and communicate with any number of sources referenced herein and other sources. For example, the configuration server 104 may be implemented as a cloud-based platform or may be distributed across multiple physical locations.

According to the illustrated embodiment, the target device 102 is configured to send a configuration request message to the configuration server 104 for authorization to operate pursuant to a set of device operating/functioning parameters (e.g., frequency, transmit power, etc.) during a pre-authorized interval of time and at a pre-authorized geographic location. In order to obtain the authorization from the configuration server 104, the configuration request message in some embodiments must indicate the geographic location of the target device 102, e.g., within a certain tolerance (e.g., plus or minus five meters) and at a certain confidence level (e.g., at least 95%).

If the target device 102 is able to determine its own geographic location, e.g., particular GPS coordinates obtained via a GPS chip of the target device that is able to receive and process GPS signals, then the geographic location of the target device 102 to be included with the configuration request message may comprise the particular GPS coordinates of the target device 102 generated based on the GPS chip and the available GPS signals.

If the target device 102 is unable to obtain its own particular GPS coordinates to be included with the configuration request message, the target device 102 in accordance with one or more aspects of the disclosure may determine its geographic location based on reference to a polygon-shaped geographical region having an interior that includes the geographic location of the target device. For instance, the target device may comprise a polygon computing engine 106 that is configured to facilitate the determining, e.g., defining, of a polygon-shaped geographical region based on geographic other device locations that correspond to vertices of the polygon-shaped geographical region. For example, each of the geographic locations may be considered to be an x/y coordinate (e.g., a longitude/latitude coordinate), and the polygon-shaped geographical region may be determined using a known technique, such as a convex hull technique, to include vertices at the x/y coordinates corresponding to the geographic locations.

In accordance with one or more embodiments, the polygon computing engine 106 may access the three or more sets of GPS coordinates, e.g., based on GPS-enabled access point location data 110 stored in a data repository 108, to compute the polygon-shaped geographical region. In one or more embodiments, the GPS-enabled access point location data 110 corresponds to a set of GPS coordinates that are (a) generated and communicated by a corresponding set of the GPS-enabled access points 122a-122n, (b) received by the target device 102, e.g., via the wired and/or wireless communication links and/or network(s), and (c) stored at the target device 102 and/or stored by the target device 102, e.g., to the data repository 108. While illustrated within the target device 102, the polygon computing engine 106 may be implemented within any other component (e.g., a network management station) of the system 100. When implemented within another system component, the other system component computes the location for the target device 102 in accordance with one or more embodiments.

For elevation or height, one or more GPS-enabled access points, e.g., on a floor of a building, may obtain z coordinate information via GPS signals along with the GPS information indicating x and y GPS coordinates. Additionally or alternatively, the z coordinate information may be manually input. Hence, in totality there may be three coordinate dimensions. Namely, the three coordinate dimensions may comprise x/y coordinate information based on GPS signal triangulation techniques and z coordinate information which may indicate a height from mean sea level or a height above ground level.

In addition to being communicatively coupled with the configuration server 104, the target device 102 further in the illustrated embodiment is communicatively coupled, e.g., via wired and/or wireless communication links and/or network(s), with one or more location-assistance devices able to provide to the target device 102 three or more geographic location coordinates. The one or more location-assistance devices may comprise, in an example, three or more location-enabled devices communicatively coupled to the target device 102, e.g., within a same network, to provide three or more sets of GPS coordinates, respectively, to the target device 102 for enabling the target device 102 to define vertices of the polygon-shaped geographical region.

As illustrated and described herein, the three or more location-enabled devices may be placed along a perimeter of a building and configured to broadcast their geographic coordinates to the target device 102 within the building. By virtue of the target device 102 being within the building, the target device 102 can be considered to be within a polygon-shaped geographical region formed by the three or more location-enabled devices. Hence, this polygon-shaped geographical region can be used by the target device 102 to identify its geographic location.

In the illustrated embodiment, the location-enabled devices comprise three or more GPS-enabled access points 122a-122n. The GPS-enabled access point 122a, the GPS-enabled access point 122b, and the GPS-enabled access point 122n may include a GPS chip 124a, a GPS chip 124b, and a GPS chip 124n, respectively, in communication with GPS signal sources 126. The GPS-enabled access points 122a-122n, thus, are configured to generate three or more sets of GPS coordinates and communicate them to the target device 102.

In addition to comprising the polygon computing engine 106, the target device 102 further comprises or is communicatively coupled, e.g., via a wired or wireless network, to the data repository 108. The data repository 108 in accordance with one or more embodiments is configured to store or access one or more of GPS-enabled AP location data 110, polygon definition information 112, a target device computed location 116, accuracy criteria 114, and configuration data 120.

As used herein, the GPS-enabled AP location data 110 may comprise, for example, location information corresponding to the three or more sets of GPS coordinates such as may be (a) communicated, e.g., wired and/or wirelessly, to the target device 102 from the GPS-enabled access points 122a-122n and (b) stored, e.g., at the data repository 108 as GPS-enabled AP location data 110, by the target device 102. Each of the GPS chips 124a-124n may comprise an electronic component configured to receive signals from GPS satellites, such as the GPS signal sources 126, and use those signals to determine its precise location. For example, the GPS chip 124a may calculate its precise location and provide this information to the GPS-enabled access point 122a into which it is integrated. In a typical embodiment, the precise location is generated by GPS chip 124a in the form of a latitude and a longitude coordinate, along with an altitude metric if available. The GPS chip 124a may in embodiments be configured to continually update its location conditioned on the GPS chip 124a being able to receive signals from enough GPS satellites.

As used herein, the polygon definition information 112 may include, for example, information specifying or indicating types and/or geographic locations of devices from which to collect the three or more sets of GPS coordinates, a number (e.g., three) of sets of GPS coordinates to collect from GPS-enabled access points prior to initiating computation of the polygon-shaped geographical region, a type of polygon to compute (e.g., linear or nonlinear), and a technique (e.g., Graham scan) to implement for computation of a particular polygon (e.g., of a convex hull polygon).

As used herein, the accuracy criteria 114 may include, for example, a confidence level, e.g., as disclosed herein, and information regarding how to obtain or compute the confidence level. The accuracy criteria 114, the confidence level, and/or the information may correspond to or be described, referenced, or indicated by a level of geolocation confidence as in the 47 CFR 15.407 (k)(9)(i) and/or the Wi-Fi Alliance AFC Device Interface Specification provisions. In a particular example, a polygon-shaped geographical region may be computed by the target device 102 along with a reliability metric, e.g., confidence level or other information associated with the accuracy criteria 114, associated with or determined for the computed polygon-shaped geographical region. In a typical implementation, the accuracy criteria 114 and/or the confidence level may be expressed as a percentage value corresponding to similar expressions of same in the above-referenced provisions.

As used herein, the target device computed location 116 may correspond, for example, to a region determined for reporting by the target device 102 to the configuration server 104. The region may be specified by a particular size and/or shape and specified as being reliable/accurate within a certain confidence level. For example, the region may be specified as being reliable/accurate based on, corresponding to, or in association with the accuracy criteria 114. For instance, the target device computed location 116 may specify a determined position including a group of geographic coordinates (e.g., describing a polygon-shaped geographical region), a location uncertainty (e.g., in meters), and a confidence level (e.g., including a percentage value).

As used herein, the configuration data 120 may in certain embodiments correspond to the authorization sent by the configuration server 104 responsive to the configuration request message sent by the target device 102, and may specify (i.e., authorize) particular operating/functioning parameters for a particular interval of time and geographic location of the target device 102. In example implementations, the operating/functioning parameters may include one or more of approved frequencies or approved power levels for a specified interval of time and geographic location. For example, the authorization may constitute or include the configuration data 120. To illustrate, the configuration data 120 may be created or correspond to information provided by the configuration server 104 responsive to the configuration request message sent by the target device 102 pursuant to wireless frequency coordination (e.g., Wi Fi 6E) standards or similar provisions. Such standards or provisions are described and referenced by FCC or Wi-Fi Alliance rules and procedure documents in connection with, for example, AFC systems and devices.

### 3. Determining a Location of a Device for Configuring the Device

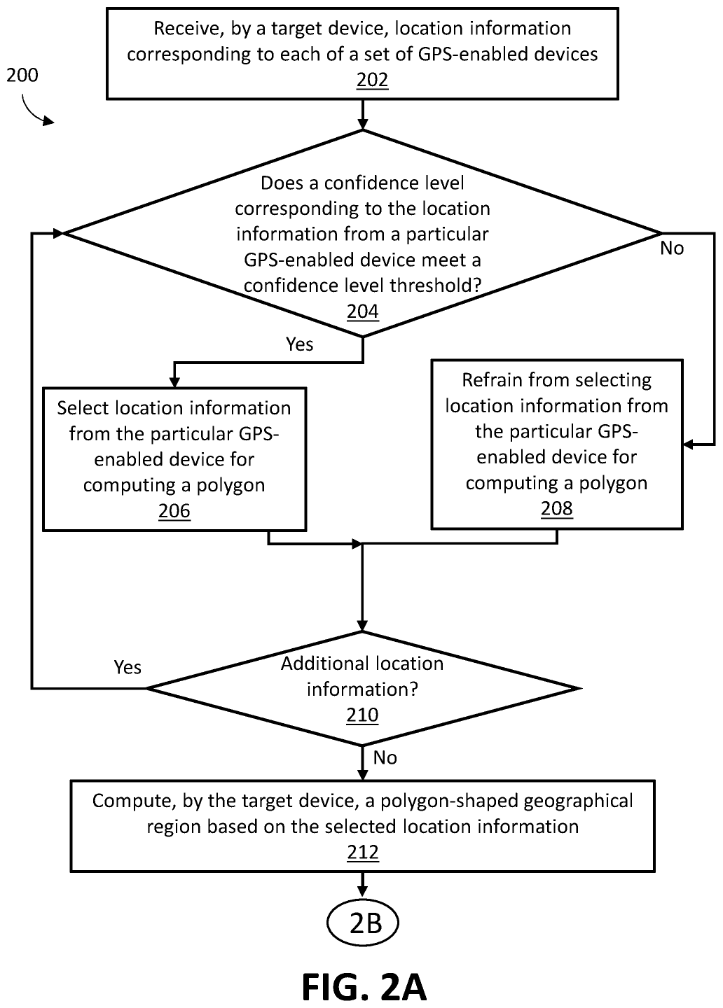

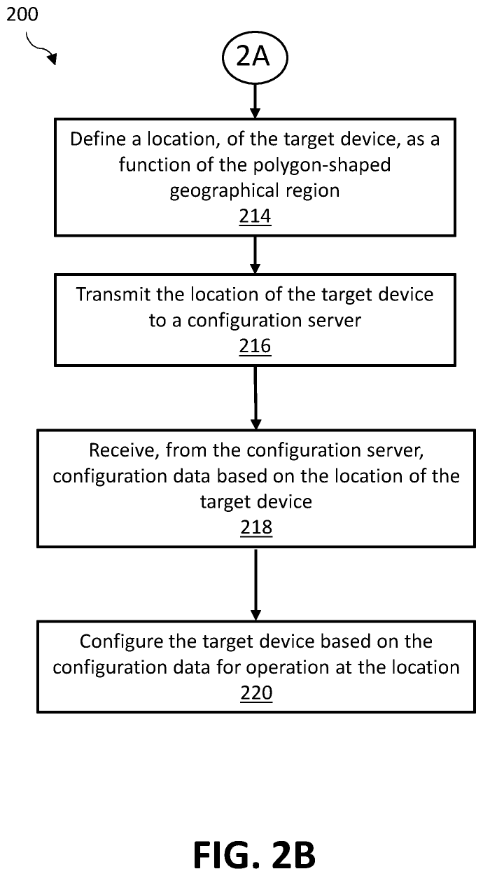

FIGS. 2A and 2B illustrate an example set of operations for enabling a communication device to operate, e.g., wirelessly communicate, at a particular approved geographic location, during a particular approved time interval, and according to particular device-approved operating/functioning parameters. One or more operations illustrated in FIGS. 2A and 2B may be modified, rearranged, or omitted altogether. Accordingly, the particular sequence of operations illustrated in FIGS. 2A and 2B should not be construed as limiting the scope of one or more embodiments of the disclosure.

The operations may be performed at the computing system 100, e.g., by the target device 102, to enable operation, e.g., wireless communication, by the target device 102 on at least one device-approved frequency at a device-approved geographic location in accordance with one or more embodiments of the disclosure. In certain embodiments of the disclosure, all or portions of one or more of the operations may correspond to, e.g., be performed by, hardware and/or software configured to perform the operations.

In one or more embodiments, a communication device, e.g., the target device 102, receives location information corresponding to each of a set of GPS-enabled devices (Operation 202). For example, the target device 102 may detect broadcast signals from the set of the GPS-enabled devices to receive the location information. Alternatively, the target device 102 may transmit a request for the location information to, or for receipt by, the set of the GPS-enabled devices, e.g., that are known to be along a perimeter of a region (e.g., building) that includes the target device 102. As described above, each of the GPS chip 124a, GPS chip 124b, and GPS chip 124n may be configured to receive signals from satellites in the GPS, such as the GPS signal sources 126, and use those signals to determine its precise location. In the example, the GPS signal sources 126 are oriented in a constellation of satellites orbiting the Earth to continuously broadcast signals containing information about their precise positions and the current time. In accordance with a typical implementation, a GPS chip, such as the GPS chip 124a, receives signals from particular GPS signal sources 126, e.g., three or more GPS satellites, that are overhead. The GPS chip performs triangulation, e.g., based on measuring times for the signals to travel from the three or more GPS satellites to the GPS chip, to calculate its distance from each of the three or more GPS satellites. The GPS chip further may be configured to perform trilateration, in a manner similar to triangulation but in three dimensions, to determine its exact position.

At Operation 204, the communication device may determine whether a reliability metric, e.g., confidence level or accuracy level, associated with, e.g., determined for, the location information indicates that the location information is reliable or accurate enough for use in computing a polygon-shaped geographical region. In the illustrated embodiment, the location information may be determined to be reliable or accurate enough for use in computing a polygon-shaped geographical region if the confidence level or accuracy level meets a confidence level threshold or accuracy level threshold. For example, location information from a particular GPS-enabled device, e.g., the GPS-enabled access point 122a, may be determined to meet the confidence level threshold, e.g., a 95% confidence level that the location information is accurate. The communication device may determine or access information relating to either or both of the confidence level and the confidence level threshold based on the accuracy criteria 114.

If the confidence level (reliability metric) associated with the location information from the particular GPS-enabled device meets the confidence level threshold, that location information is selected for computing a polygon-shaped geographical region (Operation 206).

On the other hand, if the confidence level (reliability metric) associated with the location information from the particular GPS enabled device does not meet the confidence level threshold, the communication device refrains from selecting the location information from the particular GPS-enabled device for computing the polygon-shaped geographical region (Operation 208).

At Operation 210, the communication device may determine whether additional potentially-usable location information, e.g., the set of GPS coordinates from the GPS-enabled access point 122b, has been received by the communication device and if so initiates Operations 204-208 for the additional location information. A determination, e.g., at Operation 210, of whether additional location information may be potentially usable may be performed, e.g., based on the polygon definition information 112. For example, a number of sets of GPS coordinates selected via Operations 204-208 may be counted. If the counted number does not meet a threshold number (e.g., is less than a predetermined minimum number, such as three) of sets of GPS coordinates that need to be collected prior to initiating computation of the polygon-shaped geographical region, e.g., as indicated by the polygon definition information 112, then selection of additional location information, e.g., sets of GPS coordinates, may be indicated and initiated.

Once a sufficient number of sets of GPS coordinates, e.g., satisfying criteria indicated by the polygon definition information 112 is obtained, a polygon-shaped geographical region is determined according to the described example method. In the illustrated implementation, the communication device computes a polygon-shaped geographical region based at least part on the selected location information (Operation 212). For example, one or more processors at the target device 102 may perform computations to determine the polygon-shaped geographical region based on the location information corresponding to each of the GPS-enabled access points 122a, 122b, and 122n. The polygon-shaped geographical region may be determined such that each of the plurality of GPS-enabled devices is located approximately along a perimeter of the polygon-shaped geographical region and such that the target device is located within the polygon-shaped geographical region. In an embodiment, the target device 102 may determine (and/or be configured to know or be configured to operate based on knowledge) that it is within the polygon-shaped geographical region based on the polygon definition information 112 and/or may make the determination that it is within the polygon-shaped geographical region to a certain confidence level or accuracy level. For example, the target device 102 may be configured to determine, e.g., using the sets of GPS coordinates, that it is within the polygon-shaped geographical region based on: information indicating a relative position of the target device 102 on a building floor (e.g., somewhere on the building floor); relative positions of the GPS-enabled access points 122a, 122b, and 122n (e.g., that they are each positioned at a perimeter of the building floor); and/or based on a triangulation technique.

In one or more embodiments, the polygon-shaped geographical region is created at Operation 212 using one or more processors at the target device 102 and information stored at the data repository 108 including, for example, the GPS-enabled AP location data 110 and/or polygon definition information 112. In an example implementation, the polygon-shaped geographical region may be defined at the target device 102 as a polygon based on the GPS-enabled AP location data 110 using a known technique (e.g., Graham scan) to generate via the one or more processors a particular polygon (e.g., a convex hull polygon). A particular Graham's scan method, for example, may be used to detect the convex hull of a targeted region, e.g., having vertices in a horizontal plane corresponding to geographic coordinates reported by a set of the GPS-enabled access points 122a-122n.

Implementing the Graham's scan method may correspond to detecting the convex hull for a group geographic coordinates of a group of GPS-enabled access points 122a-122n in a two-dimensional environment, e.g., on a building floor. An initial geographic coordinate with a lowest y-coordinate (e.g., longitude value) may be selected from the group geographic coordinates. Then, the geographic coordinates for the rest of the group of geographic coordinates may be sorted in increasing order of an angle calculated between each geographic coordinate and the initial geographic coordinate along an axis. Here, if two geographic coordinates are determined to have a same calculated angle, only the geographic coordinate with a furthest distance (e.g., from the initial geographic coordinate) is retained. An Euclidean distance technique may be used to calculate the distances in an example embodiment. According to the Graham's scan implementation, the ordered geographic coordinates (e.g., ordered from the sorting) are iteratively processed by identifying an angle formed by each set of three sequential geographic coordinates. For instance, each set of three sequential geographic coordinates may correspond to a previous geographic coordinate, a current geographic coordinate, and a next geographic coordinate. The current geographic coordinate for a given set is retained if the corresponding identified angle indicates a counterclockwise direction. Otherwise, the current geographic coordinate is discarded. Once the iterative processing for the sets is concluded, a combination of the retained geographic coordinates describes the convex hull of the targeted region. The resulting convex hull may then be used to define a particular polygon-shaped geographical region that includes the retained geographic coordinates corresponding to the group, or to a subgroup, of GPS-enabled access points 122a-122n.

The communication device may then define a geographic location, e.g., corresponding to a geographic location of the target device 102, as a function of the polygon-shaped geographical region (Operation 214). The defined geographic location may be associated with or include the target device computed location 116 and/or the accuracy criteria 114. Alternatively, or additionally, the target device 102 may select a specific location within the polygon-shaped geographical region as the location of the target device 102. For example, an approximate center of the polygon-shaped geographical location may be computed and selected as the location of the target device 102. Furthermore, techniques such as triangulation may be used to select a location within the polygon-shaped geographical region for the target device 102 that has been determined in accordance with one or more embodiments.

Operation 216 includes transmitting the geographic location of the communication device to a configuration server, e.g., the configuration server 104. For example, the target device 102 may send a configuration request message to the configuration server 104 for authorization to operate pursuant to a set of device operating/functioning parameters, a pre-authorized interval of time, and a pre-authorized geographic location.

At Operation 218, the communication device receives, from the configuration server, configuration data based on the geographic location of the communication device sent to the configuration server. The communication device may then be configured to operate based on the configuration data (Operation 220). In one or more embodiments, the communication device may comprise an access point, and the configuration data may comprise one or more of communication frequencies approved by the configuration server 104 for use by the access point. Additionally or alternatively, the configuration data may comprise one or more of a radio transmit power level range approved by the configuration server 104 for use by the access point, or a policy selected from a group comprising a security policy and an access policy. In one or more embodiments, the polygon-shaped geographical region may correspond to a footprint of a building floor, e.g., rectangular or any other shape, that includes the communication device. In one or more embodiments of the disclosure, the policy may be associated with the building floor, e.g., that is included within the polygon-shaped geographical region.

In certain embodiments, the communication device is configured to store and/or access instructions embodied on one or more non-transitory media and comprises or is configured to use one or more processors to execute the instructions to cause performance of a plurality of operations corresponding to one or more of the above-referenced Operations 202-220. Receiving the location information (Operation 202) may comprise receiving broadcast messages from each of the plurality of GPS-enabled devices 122a-122n, where each of the broadcast messages may comprise at least a portion of the location information. Additionally or alternatively, receiving the location information (Operation 202) may comprise receiving unicast messages from each of a plurality of the GPS-enabled devices 122a-122n responsive to the communication device transmitting a broadcast message for the location information, where each of the unicast messages may comprise at least a portion of the location information.

The operations may further comprise receiving, by the communication device, additional location information corresponding to a particular GPS-enabled device that is not included in the plurality of GPS-enabled devices. The additional location information may comprise a particular location of the particular GPS-enabled device and a confidence level corresponding to the particular location. The operations may further comprise determining whether the confidence level meets a confidence level threshold, and responsive to determining that the confidence level does not meet the confidence level threshold, refraining from using the particular location of the particular GPS-enabled device to compute the polygon-shaped geographical region.

The communication device may include a first access point configured to perform a first transmission of the location to the configuration server, wherein the location is identified in the first transmission as a location of the first access point. The first access point may further be configured to receive, from the configuration server, first configuration data that is based on the first transmission and that includes one or more frequencies as first operation frequencies approved for use by the first access point during a first interval of time. The first access point may then be authorized for operation based on the first configuration data. A second access point, e.g., of the computing system 100, may be configured to perform a second transmission of the location to the configuration server, wherein the location is identified in the second transmission as a location of the second access point. The second access point may further be configured to receive, from the configuration server, second configuration data that is based on the second transmission and that includes the one or more frequencies as second operation frequencies approved for use by the second access point during a second interval of time. Subsequently, the second access point may be authorized to operate, e.g., communicate, based on the second configuration data. The first interval of time and the second interval of time may at least partially overlap according to one or more embodiments of the disclosure.

In accordance with one or more embodiments, the first access point may be configured to determine the polygon-shaped geographical region and to indicate to a configuration server that the first access point is located within the polygon-shaped geographical region, and the second access point may be configured to receive GPS data defining the polygon-shaped geographical region and to indicate to the configuration server that the second access point is located within the polygon-shaped geographical region.

### 4. Example Embodiment

A detailed example is described below for purposes of clarity. Components and/or operations described below should be understood as specific examples which may not be applicable to certain embodiments. Accordingly, components and/or operations described below should not be construed as limiting the scope of any of the claims.

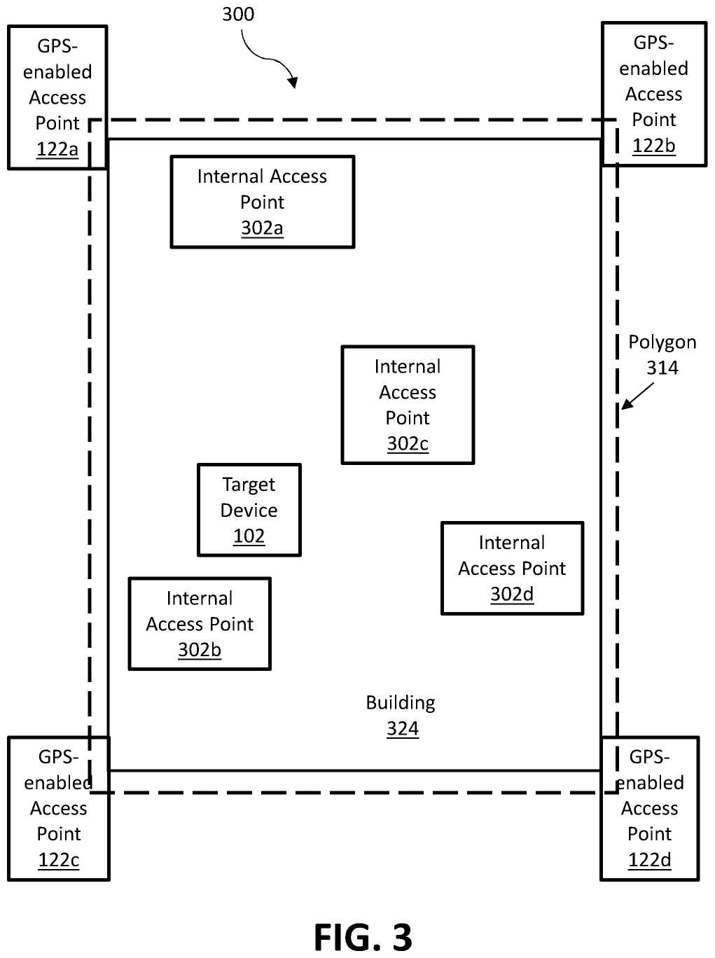

FIG. 3 depicts an operating environment 300 that includes the target device 102, the GPS-enabled access point 122a, the GPS-enabled access point 122b, a GPS-enabled access point 122c, and a GPS-enabled access point 122d in accordance with an example embodiment of the disclosure. The target device 102 is positioned within an interior region of a building 324 along with an internal access point 302a, an internal access point 302b, an internal access point 302c, and an internal access point 302d. As elucidated in FIG. 3, the GPS-enabled access points may be positioned along a perimeter of the building 324 and/or at GPS signal-reception areas in or outside of the building 324. For example, the GPS-enabled access points may be placed at locations corresponding to the four corners of the building 324, corresponding to a polygon 314, and at a particular elevation, e.g., a building floor level.

In certain embodiments of the disclosure, a minimum of three GPS-enabled access points are needed by the target device 102 to compute a polygon-shaped geographical region. The number of GPS-enabled access points may be greater than three or greater than four depending on, for example, the size or shape of a particular building, e.g., at a given elevation. Each GPS-enabled access point may be located close to or on the building 324, e.g., at the building surface, such that a closed-loop polygon 314 formed therefrom (e.g., via drawing a line from one GPS-enabled access point to the next and so forth) will meet a requirement of covering as much of a footprint of the building 324 as possible (e.g., for a given floor or a given height). In modified embodiments, one or more of the GPS-enabled access points may not be deployed on or adjacent to the building 324 exterior or interior surface. For example, one or more of the GPS-enabled access points may be deployed close to or in proximity to, e.g., within a wireless communication range, of the exterior or of a window of the building 324.

The building 324 typically will be, but need not necessarily be, a covered and/or walled building, a sheltered building, or some physical structure or location at which or in which one or more of the internal access points are unable to obtain reliable GPS location coordinates for submission to the configuration server 104 in configuration-request messages requesting configuration data. In one or more example embodiments of the disclosure, one or more of the configuration-request messages comprises an available spectrum inquiry request message, e.g., transmitted to the configuration server 104. In the illustrated embodiment, the target device 102 receives location broadcasts from three or more GPS-enabled access points. Alternatively, the target device 102 may send a request to each GPS-enabled access point and each GPS-enabled access point may respond to the request, e.g., via a unicast message, or via performance of a broadcast. In additional or alternative embodiments, each of multiple internal access points may broadcast requests for geographic location information for receipt by GPS-enabled access points, and corresponding (e.g., receiving) GPS-enabled access points may reply with corresponding unicast message(s) including corresponding geographic location information.

Any secure means of communicating the GPS-enabled access point location coordinates to the target device 102 may be used; according to an implementation, the target device 102 is configured to receive the GPS-enabled access point location coordinates automatically as compared to requiring entry of each via manual input. A level of security associated with this communicating should at a minimum ensure that data, e.g., location coordinates, is not signal wise degraded or information wise altered; in other words, the integrity of the geographic location data from the GPS-enabled access points should be maintained.

Once a previously-specified minimum number, e.g., three or four, of GPS-enabled access point locations has been obtained, a polygon-shaped geographical region can be determined. The polygon-shaped geographical region can be used as the device, e.g., target device 102, location in a request message to the configuration server 104 to obtain configuration data indicating a set of approved frequency and power operating/functioning parameters for use by the target device 102 at (within) the geographic location specified by the polygon-shaped geographical region. In particular embodiments, the request message from the target device 102 to the configuration server 104 and the reply from the configuration server 104 indicating the configuration data are performed in accordance with an AFC based protocol.

In an example implementation, one or more of internal access point 302a, internal access point 302b, internal access point 302c, and internal access point 302d each include an operating (e.g., able to receive GPS signals) GPS chip. The target device 102 may receive and use geographic locations of devices including internal access point 302a, internal access point 302b, internal access point 302c, and internal access point 302d to the extent known or ascertainable as vertices of a polygon-shaped geographic region for reporting as the geographic location of the target device 102. In an alternative or additional example, the target device 102 may use the geographic locations of devices including internal access point 302a, internal access point 302c, and GPS-enabled access point 122c to the extent known or ascertainable as vertices of a polygon-shaped geographical region for reporting the location of the target device 102. Further, in another example, the internal access point 302c may use the geographic locations of devices including internal access point 302a, internal access point 302b, and internal access point 302d to the extent known or ascertainable as vertices of a polygon-shaped geographical region for reporting the location of the target device 102 to the configuration server 104. In these or other examples, internal access points that are deployed relatively close to edges of the building 324, e.g., one or more of internal access point 302a, internal access point 302b, and internal access point 302d, may be capable of obtaining their own geographic locations, e.g., via GPS chips included thereon.

In certain embodiments, multitudes e.g., hundreds, of internal access points and GPS-enabled access points may be deployed, e.g., internally on ceilings or walls and externally at or on exterior surfaces of the building 324 or a structure. Each of the internal access points and GPS-enabled access points may correspond to a single access point design or architecture, e.g., model, configurable to operate as an internal access point and/or as a GPS-enabled access point. In such an implementation, the model may initially seek to obtain its GPS coordinates via GPS signals directly and if unable to obtain such information (e.g., if unable to lock onto GPS satellite signals and/or unable to obtain GPS with certain level of accuracy and/or such as by virtue of different providers of GPS services) may operate as an internal access point, e.g., to obtain its location information based on geographic coordinates of other devices and/or polygon zone data as described herein for reporting to the configuration server 104. For instance, after a predetermined number of GPS-location determination attempts and/or following a predetermined amount of time during which a given access point device is unable to obtain directly its GPS location, the access point device may initiate a polygon-shaped geographical region identification method as described herein.

Alternatively, two or more access-point types or access-point models of differing designs/architectures may be deployed where, for example, one of the access-point models operates as an internal access point configured or configurable without GPS functionality and the other access-point model of the models operates as a GPS-enabled access point configured or configurable with GPS functionality, e.g., with a GPS chip. For instance, each of the GPS-enabled access points may be configured to obtain its GPS coordinates via GPS signals, e.g., via an included GPS chip, and transmit same, e.g., in a location transmission sent via wired, wireless, beacon (broadcasted by a GPS-enabled access point), and/or poll response (to a poll request from an internal access point), for receipt and use by one or more internal access points.

In certain embodiments, following acquisition of its GPS coordinates, a GPS-enabled access point may initiate reporting, e.g., broadcasting, in periodic messages, e.g., on its backhaul via wired and/or wireless communication paths, its geographic location for receipt and use by one or more other access points. In certain contexts or embodiments, a GPS-enabled access point may broadcast location transmissions according to a set period or aperiodically, may broadcast location transmissions relatively infrequently based on a period, and/or may send/broadcast its location transmission responsive to one or more particular events such as a poll or other type of request from another device such as an internal access point powering up. In the latter case, each of one or more GPS-enabled access points, upon receiving such a request from an internal access point, e.g., powering up, may broadcast location transmissions (e.g., location messages) and/or may reply with, e.g., via a unicast message corresponding to a location transmission, comprising geographic coordinates.

In one or more embodiments, the poll or other type of request may indicate criteria such as information specifying which GPS-enabled access point(s) should reply with location transmissions or location messages. The criteria may specify, for example, that only GPS-enabled access points having (a) real time or near-real time, or otherwise verifiable as current location coordinates, (b) an optimal or desired height or elevation, (c) a particular identity, signature, characteristic, or geographic coordinate range, (d) a manufacturer identity, and/or (e) a location at particular region such as an identified building, building floor, sub-region on a floor, and so forth, may reply or are authorized to reply to the poll or other type of request with a location transmission. It is also possible according to some embodiments that a GPS-enabled access point having a GPS chip may be deployed at a location which is deep inside or otherwise shadowed by the building 324 such that GPS-enabled access point is not able to obtain a GPS lock; in such a scenario, the GPS-enabled access point may initiate operation, e.g., automatically, as an internal access point.

In embodiments, one or more of the GPS-enabled access point 122a, GPS-enabled access point 122b, GPS-enabled access point 122c, and GPS-enabled access point 122d may transmit (e.g., broadcast) its geographic location, e.g., along with a device identifier such as a media access control (MAC) address. The transmission further may include information identifying the sending device, e.g., communication device, as a location-enabled access point, e.g., a GPS-enabled access point. According to an aspect of the disclosure, for a group of access points deployed in and around a building, the access points that are broadcasting will typically be disposed about the periphery of the building, e.g., where they can “see” the open sky and obtain locks onto GPS capabilities, while other access points not broadcasting their locations to location-disabled access points will typically be at interior or signal-shaded locations.

If an example communication device, such as a GPS-enabled access point, is located inside of the building 324, e.g., near the target device 102 location, the communication device likely will not be able to obtain the communication device's own geographic coordinates by virtue of being sheltered at least partially from GPS signals needed by the communication device's GPS chip to determine the communication device's location coordinates. Hence, following a determination that the communication device is unable to obtain its GPS location coordinates, e.g., based on a threshold number of GPS location attempts and/or following a threshold interval of time in which the communication device is unable to obtain directly its GPS location, the communication device may initiate a polygon-shaped geographical region location identification method as described herein.

On the other hand, in example embodiments including a communication device corresponding to a smartphone or other cellular device able to obtain information indicating its geographic position via means other than direct GPS signals, the indicated geographic position may be rejected, by the communication device as not being precise and/or not being associated with an associated high confidence level. Such rejection may be determined based on, for example, information corresponding to one or more of the polygon definition information 112 and the accuracy criteria 114.

For instance, the communication device may identify a geographical area or a geographical region as its location but the identified geographical area or geographical region may be relatively imprecise, not sufficiently reliable for reporting to the configuration server 104, and/or of relatively low granularity relative to a granularity required for use in reporting to the configuration server 104. Additionally or alternatively, the identified geographical area or geographical region may not contain sufficient information or content for use by the communication device in reporting, to the configuration server 104, the communication device's geographic location. The communication device in such example embodiments may determine to initiate a polygon-shaped geographical region location identification method as described herein. According to additional or alternative implementations, a communication device, e.g., the smartphone of the above example, determining to initiate a polygon-shaped geographical region location identification method typically will not broadcast its geographic location to internal access points, e.g., by virtue of the communication device's geographic location being sub-optimal for use by other internal access points in performing corresponding polygon-shaped geographical region location identification methods.

In typical embodiments, each location transmission, e.g., sent by a GPS-enabled access point for receipt by at least one internal access point, includes information specifying an accuracy or precision of the location being transmitted, e.g., of the GPS coordinates. For example, a location transmission may include information indicating that the coordinates transmitted by the GPS-enabled access point for use by an internal access point are associated with an accuracy of plus or minus one meter or an accuracy of plus or minus 10 meters. As another example, the location transmission may include information indicating that the geographic coordinates transmitted by the GPS-enabled access point for use by an internal access point are associated with a confidence level of for instance 92% or with a confidence level for instance of 95% or greater.

An internal access point receiving the location transmission may compare the confidence level to a threshold confidence level, for example, to determine whether or not to use the geographic coordinates of the location transmission for use by the internal access point in performing a polygon-shaped geographical region location identification calculation. In such example embodiments, the accuracy or confidence level of the coordinates transmitted by the GPS-enabled access point may be determined, e.g., by the GPS-enabled access point sending the location transmission and/or by a recipient of the transmission, based on a means/technique of determining/acquiring the geographic coordinates, a consistency and/or strength of signal(s) used to determine/acquire the geographic coordinates, whether the geographic coordinates indicate a suboptimal or undesired height or elevation of the corresponding GPS-enabled access point, whether an identity, signature, characteristic or geographic coordinates of a device or access point sending the location transmission(s) indicate(s) a suboptimal or undesired (i) device, e.g., manufacturer, etc., of the corresponding GPS-enabled access point or (ii) location, e.g., a different building, etc., of the corresponding GPS-enabled access point, and so forth. The accuracy or confidence level may be determined based on, for example, information corresponding or relating to one or more of the polygon definition information 112 and the accuracy criteria 114.

Once an internal access point has received, and determined as qualified, e.g., as sufficiently accurate, the geographic coordinates of three or more GPS-enabled access points, computing a polygon-shaped geographical region may be initiated at the internal access point. For example, the geographic coordinates of each GPS-enabled access point can be considered as a corner or vertex of the polygon-shaped geographical region to be determined. To sort the vertices of the GPS-enabled access point 122a, GPS-enabled access point 122b, GPS-enabled access point 122c, and GPS-enabled access point 122d in an example implementation of the disclosure, a first set of the geographic coordinates containing a maximum longitude value of the four longitude values associated with the four geographic coordinates may be determined as corresponding to one side or corner of the polygon-shaped geographical region, and a second set of the geographic coordinates containing a minimum longitude value of the four longitude values associated with the four geographic coordinates may be determined as corresponding to an opposite side or corner of the polygon-shaped geographical region.

If the first set and the second set are the same set, e.g., in whole or in part, then other considerations or aspects may be implemented to select a first side or corner and to select a second or opposite side or corner of the polygon-shaped geographical region. Further, as an additional/alternative aspect or example, two of the sets of geographic coordinates containing a greatest longitude value(s) can be considered as corresponding to a side or to two adjacent corners of the polygon-shaped geographical region, and two other sets of geographic coordinates containing one or mare smaller longitude value(s) can be considered as corresponding to another or opposite side or to another two adjacent corners of the polygon-shaped geographical region. Similar analyses and computations may be performed based on latitudinal geographic coordinate values.

In accordance with certain implementations of the disclosure, once a device, such as the internal access point 302b, has determined its location, e.g., based on sufficiently reliable GPS coordinates obtained using a GPS chip at the internal access point 302b or based on a polygon-shaped geographical region determined using sufficiently reliable geographic coordinates of three or more GPS-enabled access points, the internal access point 302b may submit to the configuration server 104 a configuration-request message. The configuration-request message (e.g., which includes geographic location determined by the internal access point 302b, e.g., as a polygon-shaped geographical region with a confidence level of 95% or greater) causes the configuration server 104 to reply with configuration data corresponding to the internal access point 302b configuration-request message. The configuration data may, for example, correspond to or relate to the configuration data 120 and may include a list of frequencies, e.g., along with one or more other operating/functioning parameters, on/at which the internal access point 302b is authorized by the configuration server 104 to operate.

In the case of a particular configuration-request message specifying the internal access point 302b location as residing within a polygon (e.g., having three vertices), the geographic coordinates of the three corresponding GPS-enabled access points may be included in the configuration-request message. In particular, the geographic coordinates of the three corresponding GPS-enabled access points may be included in the configuration-request message to specify the polygon (e.g., polygon-shaped geographical region). For instance, the three geographic coordinates of three corresponding GPS-enabled access points may be listed, within the configuration-request message, in an order that corresponds to an order in which the three geographic coordinates were processed to create the polygon-shaped geographical region. For example, the order may be predetermined as a default order and/or may correspond to movement about the perimeter of the polygon-shaped geographical region, e.g., in a particular or specified direction such as a clockwise direction. In other words, the GPS coordinates of GPS-enabled access point 122a, the GPS coordinates of GPS-enabled access point 122b, and the GPS coordinates of GPS-enabled access point 122c may be included in the configuration-request message in a preset order (e.g., in the order of 122a, 122b, and 122c), and/or may be included in an ordered fashion, based on one or both of: a predefined order and an ordering criteria (e.g., specified in or indicated by the polygon definition criteria 112). The internal access point 302b may then choose, e.g., automatically, based on one or more selection policies or rules, one or more frequencies, e.g., and/or one or more other operating/functioning parameters, from among frequencies in the configuration data provided by the configuration server 104, e.g., list of frequencies, on/at which to operate.

According to one or more embodiments, multiple internal access points may use the same polygon-shaped geographic region, either calculated separately (e.g., by one or more processors at the target device 102 and by one or more processors at a second internal access point) or calculated by one device (e.g., internal access point) and shared with a second internal access point. For example, the second internal access point may determine based on information stored and/or communicated to the second internal access point, that the target device 102 is adjacent to the second internal access point or is in an immediate proximity to the second internal access point (e.g., on the same building floor). Based on this determination, the second internal access point may receive for use as its geographic location polygon zone data or other information indicating the polygon-shaped geographic region determined by the target device 102.

In some embodiments, after computing a polygon-shaped geographical region as described herein, a first internal access point may send polygon zone data identifying its polygon-shaped geographical region, e.g., via geographic coordinates identifying vertices of the polygon-shaped geographical region, to one or more second internal access points determined to be positioned in close proximity of the first internal access point. For example, each of the second internal access points may be known by the first internal access point to be located within a region bound by the vertices of the polygon-shaped geographical region determined by the first internal access point. For instance, each of the second internal access points may be known by the first internal access point to be have a position, e.g., fixed location, that is on a same building floor as the first internal access point, where the polygon-shaped geographical region is known by the first internal access point to encompass the building floor. The first internal access point may send the polygon zone data via wired, wireless, beacon (broadcasted by the first internal access point), and/or poll response (e.g., unicast message responsive to a poll request from at least one second internal access point) for receipt and use by at least one of the one or more second internal access points.

### 5. Hardware Overview

According to one embodiment of the disclosure, the techniques described herein are implemented by one or more special-purpose computing devices. The special-purpose computing devices may be hard-wired to perform the techniques, or may include: (i) digital electronic devices such as one or more application-specific integrated circuits (ASICs), field programmable gate arrays (FPGAs), or network processing units (NPUs) that are persistently programmed to perform the techniques, or (ii) one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

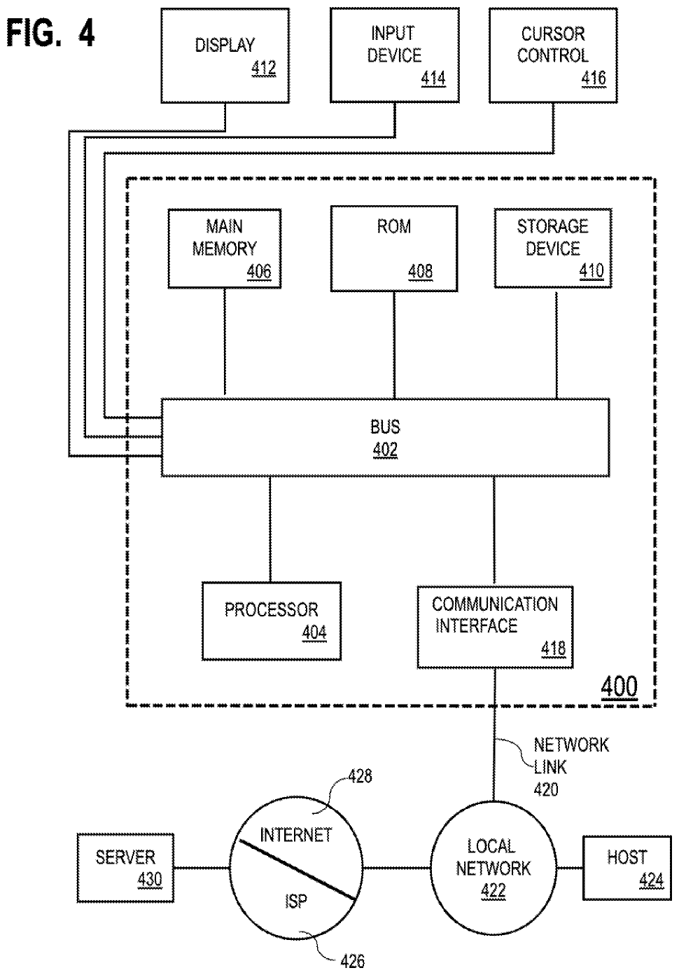

For example, FIG. 4 is a block diagram illustrating the computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a memory 406, such as a random access memory (RAM) or other dynamic storage device, coupled to bus 402 for storing information and instructions to be executed by processor 404. Memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, flash drive, or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, an axis (e.g., x) and another axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment of the disclosure, the techniques herein are performed by computer system 400 in response to processor 404 executing one or more sequences of one or more instructions contained in memory 406. Such instructions may be read into memory 406 from another storage medium, such as storage device 410. Execution of the sequences of instructions contained in memory 406 causes processor 404 to perform the process operations described herein. In alternative embodiments of the disclosure, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks or flash drives, such as storage device 410. Volatile media includes dynamic memory, such as memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or radio waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to memory 406, from which processor 404 retrieves and executes the instructions. The instructions received by memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 6. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

Embodiments are directed to a system with one or more devices that include a hardware processor and that are configured to perform any of the operations described herein and/or recited in any of the claims below.

In an embodiment of the disclosure, one or more non-transitory computer readable storage media comprise instructions which, when executed by one or more hardware processors, cause performance of any of the operations described herein and/or recited in any of the claims.

Any combination of the features and functionalities described herein may be used in accordance with one or more embodiments of the disclosure. In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicant to be the scope of the disclosure, is the literal and equivalent scope of the set of claims that issue from this application, in the specific form in which such claims issue, including any subsequent correction.

What is claimed is:

1. One or more non-transitory media having instructions which, when executed by one or more processors, cause performance of a plurality of operations, the operations comprising:
receiving location information corresponding to each of a plurality of GPS-enabled devices;
determining a polygon-shaped geographical region based on the location information corresponding to each of the plurality of GPS-enabled devices, the polygon-shaped geographical region being determined such that each of the plurality of GPS-enabled devices is located along a perimeter of the polygon-shaped geographical region,
wherein a target device is located within the polygon-shaped geographical region;
defining a location, of the target device, as a function of the polygon-shaped geographical region; and
transmitting the location to a configuration server.

2. The one or more non-transitory media of claim 1, wherein defining the location, of the target device, as a function of the polygon-shaped geographical region comprises: defining the location, of the target device, as the polygon-shaped geographical region.

3. The one or more non-transitory media of claim 1, wherein the polygon-shaped geographical region is computed such that each of the plurality of GPS-enabled devices are located at respective vertices of the polygon-shaped geographical region.

4. The one or more non-transitory media of claim 1, wherein:
the polygon-shaped geographical region corresponds to a footprint of a building floor that includes the target device,
the plurality of GPS-enabled devices are disposed along a perimeter of the building floor, and
receiving the location information comprises one or both of:
receiving broadcast messages from the plurality of GPS-enabled devices, each of the broadcast messages comprising at least a portion of the location information, and
receiving unicast messages from the plurality of GPS-enabled devices responsive to the target device transmitting a broadcast message for the location information, each of the unicast messages comprising at least a portion of the location information.

5. The one or more non-transitory media of claim 1, wherein the operations further comprise:
receiving, from the configuration server, configuration data based on the location; and
configuring the target device based on the configuration data.

6. The one or more non-transitory media of claim 5, wherein the target device includes an access point, and wherein the configuration data comprises information selected from a group comprising: (a) a radio transmit power level range approved by the configuration server for use by the access point, (b) one or more frequencies to be used for communication by the access point, (c) a security policy associated with a building floor that is included within the polygon-shaped geographical region, and (d) an access policy associated with the building floor.

7. The one or more non-transitory media of claim 1, wherein the operations further comprise:
receiving, by the target device, additional location information corresponding to a particular GPS-enabled device that is not included in the plurality of GPS-enabled devices, the additional location information comprising (a) a particular location of the particular GPS-enabled device and (b) an accuracy level corresponding to the particular location;
determining whether the accuracy level meets an accuracy level threshold; and
responsive to determining that the accuracy level does not meet the accuracy level threshold, refraining from using the particular location of the particular GPS-enabled device to compute the polygon-shaped geographical region.

8. A method, comprising:
receiving location information corresponding to each of a plurality of GPS-enabled devices;
determining a polygon-shaped geographical region based on the location information corresponding to each of the plurality of GPS-enabled devices, the polygon-shaped geographical region being determined such that each of the plurality of GPS-enabled devices is located along a perimeter of the polygon-shaped geographical region,
wherein a target device is located within the polygon-shaped geographical region;
defining a location, of the target device, as a function of the polygon-shaped geographical region;
transmitting the location to a configuration server;
receiving, from the configuration server, configuration data based on the location; and
configuring the target device based on the configuration data.

9. The method of claim 8, wherein:
defining the location, of the target device, as a function of the polygon-shaped geographical region comprises: defining the location, of the target device, as the polygon-shaped geographical region, and
the polygon-shaped geographical region is computed such that each of the plurality of GPS-enabled devices are located at respective vertices of the polygon-shaped geographical region.

10. The method of claim 8, wherein receiving the location information comprises receiving one or both of:
broadcast messages from the plurality of GPS-enabled devices, each of the broadcast messages comprising at least a portion of the location information; and
unicast messages from the plurality of GPS-enabled devices responsive to the target device transmitting a broadcast message for the location information, each of the unicast messages comprising at least a portion of the location information.

11. The method of claim 8, wherein the target device includes an access point, and wherein the configuration data comprises one or more items selected from a group comprising (a) a radio transmit power level range approved by the configuration server for use by the access point, (b) one or more frequencies approved by the configuration server for use by the target device, (c) a security policy associated with a building floor that is included within the polygon-shaped geographical region, and (d) an access policy associated with the building floor.

12. The method of claim 8, further comprising:
receiving, by the target device, additional location information corresponding to a particular GPS-enabled device that is not included in the plurality of GPS-enabled devices, the additional location information comprising (a) a particular location of the particular GPS-enabled device and (b) an accuracy level corresponding to the particular location;
determining whether the accuracy level meets an accuracy level threshold; and
responsive to determining that the accuracy level does not meet the accuracy level threshold, refraining from using the particular location of the particular GPS-enabled device to compute the polygon-shaped geographical region.

13. A system comprising a target device, the target device having one or more processors configured to cause a plurality of operations comprising:
receiving location information corresponding to each of a plurality of GPS-enabled devices;
determining a polygon-shaped geographical region based on the location information corresponding to each of the plurality of GPS-enabled devices, the polygon-shaped geographical region being determined such that each of the plurality of GPS-enabled devices is located along a perimeter of the polygon-shaped geographical region,
wherein the target device is located within the polygon-shaped geographical region; and
defining a location, of the target device, as a function of the polygon-shaped geographical region.

14. The system of claim 13, wherein the target device includes a first access point configured to:
perform a first transmission of the location to a configuration server, wherein the location is identified in the first transmission as a location of the first access point;
receive, from the configuration server, first configuration data that is based on the first transmission and that includes one or more frequencies as first operation frequencies approved for use by the first access point during a first interval of time; and
configure the first access point based on the first configuration data.

15. The system of claim 14, wherein the first configuration data comprises a radio transmit power level range approved by the configuration server for use by at least one of the target device and the first access point.

16. The system of claim 14, wherein the first configuration data comprises one or both of (a) a security policy associated with a building floor that is included within the polygon-shaped geographical region and (b) an access policy associated with the building floor.

17. The system of claim 14, further comprising a second access point configured to:
perform a second transmission of the location to the configuration server, wherein the location is identified in the second transmission as a location of the second access point;
receive, from the configuration server, second configuration data that is based on the second transmission and that includes one or more frequencies as second operation frequencies approved for use by the second access point during a second interval of time; and
configure the second access point based on the second configuration data.

18. The system of claim 17, wherein the second configuration data comprises a radio transmit power level range approved by the configuration server for use by the second access point.

19. The system of claim 17, wherein the first interval of time and the second interval of time at least partially overlap.

20. The system of claim 13, wherein:
the target device includes a first access point configured to determine the polygon-shaped geographical region and to indicate to a configuration server that the first access point is located within the polygon-shaped geographical region, and
the system comprises a second access point configured to receive GPS data defining the polygon-shaped geographical region and to indicate to the configuration server that the second access point is located within the polygon-shaped geographical region.
